(19) United States
(12) Patent Application Publication
(10) Pub. No.: US 2019/0306952 A1
(43) Pub. Date: Oct. 3, 2019

(54) SIGNAL TRANSMITTER, COMMUNICATION SYSTEM, AND LIGHTING SYSTEM

(71) Applicant: Panasonic Intellectual Property Management Co., Ltd., Osaka (JP)

(72) Inventors: Masashi MOTOMURA, Osaka (JP); Hirofumi KONISHI, Osaka (JP); Kenichi FUKUDA, Osaka (JP)

(21) Appl. No.: 16/358,270

(22) Filed: Mar. 19, 2019

(30) Foreign Application Priority Data
Mar. 29, 2018 (JP) 2018-066178

(51) Int. Cl. H05B 37/02; H05B 33/08; G05F 1/10

(52) U.S. Cl. CPC H05B 37/02; G05F 1/10; H05B 33/0815

(57) ABSTRACT

In a signal transmitter, a control circuit is configured to control a discharge switch and a control switch to transmit a transmission signal for causing the value of the output voltage to be a first voltage value or a second voltage value smaller than the first voltage value for each constant period. The control circuit controls the discharge switch and the control switch such that a voltage gradient becomes a prescribed gradient in a case where the control circuit changes the value of the output voltage from the first voltage value to the second voltage value.

### CROSS-REFERENCE TO RELATED APPLICATION

The present application is based upon and claims the benefit of priority of Japanese Patent Application No. 2018-066178, filed on Mar. 29, 2018, the entire contents of which are incorporated herein by reference.

### TECHNICAL FIELD

The present disclosure generally relates to a signal transmitter, a communication system, and a lighting system.

### BACKGROUND ART

A known conventional signal transmitter is configured to change the voltage value of a direct-current voltage to transmit transmission data. For example, Document 1 (JP 2017-201613 A) describes a signal transmitter including a series circuit of a first switch and a second switch and a capacitor connected to the first switch in parallel, wherein a direct-current voltage of the capacitor is output as an output voltage to a lighting fixture. The lighting fixture is lit with the output voltage as a power supply. Moreover, the conventional signal transmitter is configured to control the first switch and the second switch to change the value of the output voltage so as to transmit a transmission signal to the lighting fixture.

In the above-described lighting fixture serving as an example of loads, variations in power consumption vary the value of a load current supplied from the signal transmitter. Thus, in the conventional signal transmitter, when the voltage value of the output voltage is changed during transmission of the transmission signal, the degree of change such as a gradient of the output voltage varies in accordance with the power consumption by the lighting fixture. That is, in accordance with the power consumption of the lighting fixture, the gradient of the output voltage becomes steep or gentle. This causes variations of the gradient of the output voltage during transmission of the transmission signal, which may lead to unstable transmission of the transmission signal and communication abnormality.

### SUMMARY

One of the objectives of the present disclosure is to provide a signal transmitter, a communication system, and a lighting system which are configured to stabilize signal transmission and reduce communication abnormality when a transmission signal is transmitted with a voltage value of a direct-current voltage being changed.

A signal transmitter according to one aspect of the present disclosure includes: a series circuit of a discharge switch and a control switch; a capacitor; an output circuit; and a control circuit. The discharge switch and the control switch are configured to receive a direct-current voltage. The capacitor is connected in parallel to the discharge switch. The output circuit is configured to output the direct-current voltage of the capacitor as an output voltage to a load. The control circuit is configured to control the discharge switch and the control switch. The capacitor is charged to turn a value of the output voltage into a first voltage value and discharged to turn the value of the output voltage into a second voltage value smaller than the first voltage value. The control circuit changes the value of the output voltage into the first voltage value or the second voltage value by controlling the discharge switch and the control switch to generate a transmission signal. A voltage gradient is defined as an absolute value of gradient when the output voltage is increased or decreased. The control circuit controls the discharge switch and the control switch to control the voltage gradient in accordance with a predefined criteria.

A communication system according to one aspect of the present disclosure includes the signal transmitter described above and a signal receiver. The signal receiver is configured to receive a transmission signal transmitted from the signal transmitter.

A lighting system according to one aspect of the present disclosure includes the signal transmitter described above, a direct-current power supply device, and a lighting apparatus. The direct-current power supply device is configured to receive an alternating-current voltage and output a direct-current voltage to the signal transmitter. The lighting apparatus is configured to receive the output voltage from the signal transmitter and drive a light source with the output voltage. The lighting apparatus includes a signal receiver configured to receive the transmission signal.

### BRIEF DESCRIPTION OF THE DRAWINGS

The figures depict one or more implementation in accordance with the present teaching, by way of example only, not by way of limitations. In the figures, like reference numerals refer to the same or similar elements:

FIG. 1 is a block diagram illustrating a lighting system including a signal transmitter according to an embodiment of the present disclosure;

FIG. 2 is a front view illustrating a configuration of a manipulation device in the lighting system;

FIG. 3 is a timing chart illustrating operation of the signal transmitter;

FIG. 4A is a timing chart illustrating operation of the signal transmitter with a light load,

FIG. 4B is a timing chart illustrating operation of the signal transmitter with a heavy load;

FIG. 5 is a timing chart illustrating operation of the signal transmitter in an intermediate mode;

FIG. 6 is a timing chart illustrating operation of the signal transmitter in a discharge mode;

FIG. 7 is a timing chart illustrating operation of the signal transmitter in a switching mode;

FIG. 8 is a view illustrating a relationship between a dimming level in the signal transmitter and a bit configuration of a signal frame;

FIG. 9A is a waveform diagram illustrating a transmission signal for an instruction of a relatively low dimming level in the signal transmitter;

FIG. 9B is a waveform diagram illustrating a transmission signal for an instruction of a relatively low dimming level in the signal transmitter;

FIG. 9C is a waveform diagram illustrating a transmission signal for an instruction of a relatively low dimming level in the signal transmitter;

FIG. 10A is a waveform diagram illustrating a transmission signal for an instruction of an intermediate dimming level in the signal transmitter;

FIG. 10B is a waveform diagram illustrating a transmission signal for an instruction of an intermediate dimming level in the signal transmitter;

FIG. 10C is a waveform diagram illustrating a transmission signal for an instruction of an intermediate dimming level in the signal transmitter;

FIG. 11A is a waveform diagram illustrating a transmission signal for an instruction of a relatively high dimming level in the signal transmitter;

FIG. 11B is a waveform diagram illustrating a transmission signal for an instruction of a relatively high dimming level in the signal transmitter; and

FIG. 11C is a waveform diagram illustrating a transmission signal for an instruction of a relatively high dimming level in the signal transmitter.

### DETAILED DESCRIPTION

The following embodiments generally relate to signal transmitters, communication systems, and lighting systems. Specifically, the following embodiments relate to a signal transmitter, a communication system, and a lighting system which are configured to transmit, to a load, a transmission signal obtained by changing the voltage value of a direct-current voltage.

The signal transmitter and the lighting system of the present embodiment are mainly used in offices, factories, retail establishments, bureaus, and the like. Moreover, the signal transmitter and the lighting system of the present embodiment may be used in a detached dwelling house or a flat of an apartment block.

The embodiments will be described below based on the drawings.

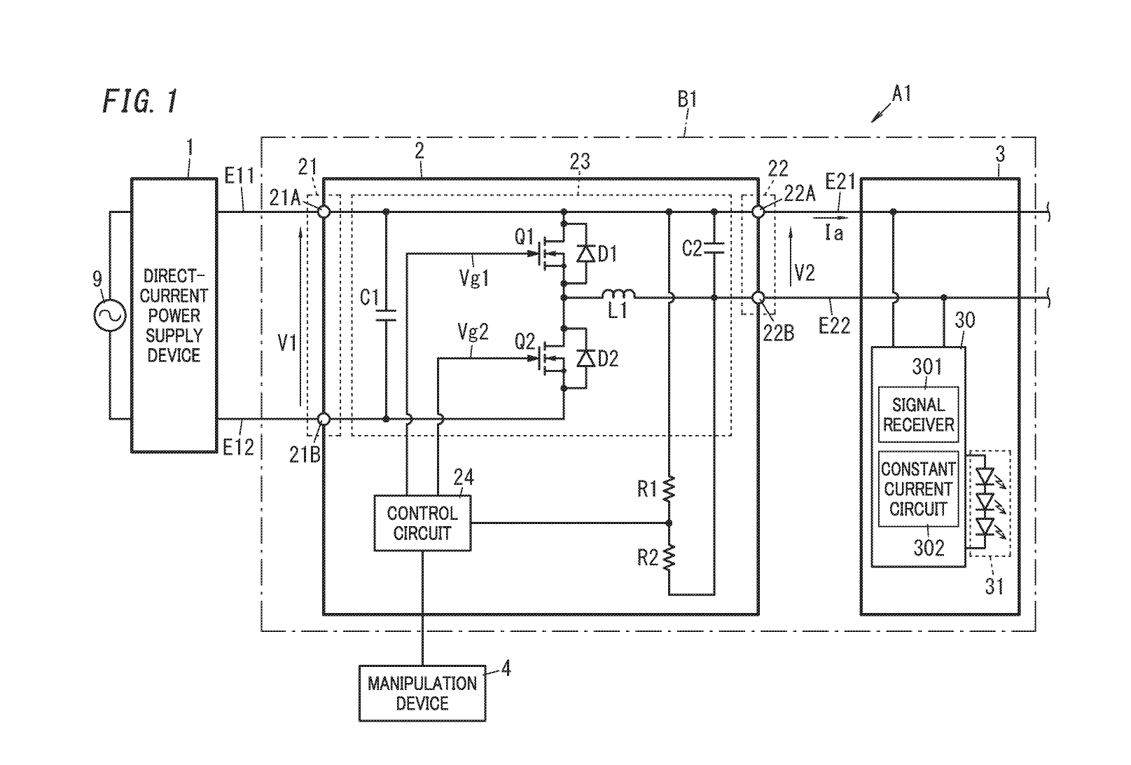

As illustrated in FIG. 1, a lighting system μl of the present embodiment includes a direct-current power supply device 1, a signal transmitter 2, a lighting fixture 3, and a manipulation device 4.

The direct-current power supply device 1 is configured to receive commercial electric power from a commercial power supply 9 to output a direct-current voltage V1. The direct-current power supply device 1 is configured to adjust the value of the direct-current voltage V1 to a prescribed value. Note that the direct-current power supply device 1 is preferably a step-up chopper circuit having a power factor correction function.

The signal transmitter 2 is configured to receive the direct-current voltage V1 via a pair of feed paths E11 and E12 from the direct-current power supply device 1 to output an output voltage V2 which is a direct-current voltage via a pair of feed paths E21 and E22. Between the pair of feed paths E21 and E22, at least one lighting fixture 3 is electrically connected. The lighting fixture 3 is configured to operate with the output voltage V2 as a power supply. That is, electric power supplied from the direct-current power supply device 1 via the signal transmitter 2 to the lighting fixture 3 is direct-current power, and power distribution from the direct-current power supply device 1 to the lighting fixture 3 is direct-current power distribution. The direct-current voltage V1 is hereinafter referred to as an input voltage V1. Note that in FIG. 1, one lighting fixture 3 is electrically connected between the pair of feed paths E21 and E22.

The lighting fixture 3 is configured to emit light with the direct-current power supplied via the pair of feed paths E21 and E22 to illuminate a space as an illumination target.

The signal transmitter 2 of the present embodiment will be described below. As illustrated in FIG. 1, the signal transmitter 2 includes an input circuit 21, an output circuit 22, a step-down circuit 23, a control circuit 24, and resistors R1 and R2.

The input circuit 21 is configured to receive the input voltage V1 which is a direct-current voltage. The input circuit 21 includes a first input terminal 21A and a second input terminal 21B. The second input terminal 21B is electrically connected to ground, in this embodiment, ground of the signal transmitter 2). That is, the first input terminal 21A is a high-potential-side input terminal, and the second input terminal 21B is a low-potential-side input terminal. As mentioned herein, “electrically connected” means direct or indirect electrical connection.

The input circuit 21 is electrically connected via the pair of feed paths E11 and E12 to the direct-current power supply device 1. The first input terminal 21A is electrically connected to one end of the feed path E11. The second input terminal 21B is electrically connected to one end of the feed path E12. The other end of each of the pair of feed paths E11 and E12 is electrically connected to the direct-current power supply device 1. In the present embodiment, the input circuit 21 is configured to receive the input voltage V1 via the pair of feed paths E11 and E12. That is, the direct-current power supply device 1 is configured to apply the input voltage V1 to the input circuit 21.

The output circuit 22 is configured to output the output voltage V2 which is a direct-current voltage. The output circuit 22 includes a first output terminal 22A and a second output terminal 22B. The output circuit 22 is electrically connected via the pair of feed paths E21 and E22 to the at least one lighting fixture 3. The first output terminal 22A is electrically connected one end of the feed path E21. The second output terminal 22B is electrically connected to one end of the feed path E22. The other end of each of the pair of feed paths E21 and E22 is electrically connected to the at least one lighting fixture 3.

The step-down circuit 23 is configured to step down the input voltage V1 to adjust the output voltage V2. As illustrated in FIG. 1, the step-down circuit 23 includes two capacitors C1 and C2, an inductor L1, and two switches Q1 and Q2. Each of the two switches Q1 and Q2 is, for example, an enhancement-type metal oxide semiconductor field effect transistor (MOSFET). Moreover, in the present embodiment, the switch Q1 corresponds to a discharge switch, and the switch Q2 corresponds to a control switch. Thus, in the following description, the switch Q1 is referred to as a “discharge switch Q1” and the switch Q2 is referred to as a “control switch Q2”.

The capacitor C1 is an input capacitor and is electrically connected in parallel to the input circuit 21. That is, the capacitor C1 is electrically connected between the first input terminal 21A and the second input terminal 21B. A high-potential-side terminal (first end) of the capacitor C1 is electrically connected to the drain (first end) of the discharge switch Q1. The gate (control end) of the discharge switch Q1 is electrically connected to the control circuit 24. The source (second end) of the discharge switch Q1 is electrically connected to the drain (first end) of the control switch Q2. The gate (control end) of the control switch Q2 is electrically connected to the control circuit 24. The source (second end) of the control switch Q2 is electrically connected to a low-potential-side terminal (second end) of the capacitor C1.

A diode D1 in FIG. 1 represents a built-in diode (body diode) of the discharge switch Q1. That is, the diode D1 is electrically connected in anti-parallel to the discharge switch Q1. Specifically, the cathode of the diode D1 is electrically connected to the drain of the discharge switch Q1 serving as a high-potential-side terminal of the discharge switch Q1, and the anode of the diode D1 is electrically connected to the source of the discharge switch Q1 serving as a low-potential-side terminal of the discharge switch Q1.

Moreover, a diode D2 in FIG. 1 represents a built-in diode of the control switch Q2. That is, the diode D2 is electrically connected in anti-parallel to the control switch Q2. Specifically, the cathode of the diode D2 is electrically connected to the drain of the control switch Q2 serving as a high-potential-side terminal of the control switch Q2, and the anode of the diode D2 is electrically connected to the source of the control switch Q2 serving as a low-potential-side terminal of the control switch Q2.

The drain of the discharge switch Q1 is electrically connected to a high-potential-side terminal of the capacitor C2. The capacitor C2 has a low-potential-side terminal electrically connected via the inductor L1 to the source of the discharge switch Q1. That is, one end of the inductor L1 is electrically connected to the source of the discharge switch Q1, and the other end of the inductor L1 is electrically connected to the low-potential-side terminal of the capacitor C2.

The capacitor C2 is a smoothing capacitor disposed between the output terminals and is electrically connected in parallel to the output circuit 22. That is, the capacitor C2 is electrically connected between the first output terminal 22A and the second output terminal 22B.

The control circuit 24 is electrically connected to the gate of the discharge switch Q1 and the gate of the control switch Q2 and is configured to perform pulse width modulation (PWM) control of the discharge switch Q1 and the control switch Q2. The control circuit 24 is configured to apply a gate voltage Vg1 to the gate of the discharge switch Q1. The control circuit 24 is configured to adjust the gate voltage Vg1 to an ON voltage Von1 serving as a voltage larger than a gate-source threshold voltage to turn on the discharge switch Q1. Moreover, the control circuit 24 is configured to adjust the gate voltage Vg1 to 0V (or a negative voltage value) to turn off the discharge switch Q1. Moreover, the control circuit 24 is configured to apply a gate voltage Vg2 to the gate of the control switch Q2. The control circuit 24 is configured to adjust the gate voltage Vg2 to an ON voltage Von2 serving as a voltage larger than the gate-source threshold voltage to turn on the control switch Q2. Moreover, the control circuit 24 is configured to adjust the gate voltage Vg2 to 0V (or a negative voltage value) to turn off the control switch Q2. The control circuit 24 performs PWM control of ON-duty in which the gate voltage Vg1 is the ON voltage Von1 and PWM control of ON-duty in which the gate voltage Vg2 is the ON voltage Von2.

The control circuit 24 includes: hardware serving as an example of computer systems such as a processor (e.g., a central processing unit: CPU) and memory; and a program executable by the processor. The program is stored in a non-transitory recording medium such as memory. For example, the memory stores a program for performing on/off-control of the discharge switch Q1 and on/off-control of the control switch Q2. In this embodiment, “control the discharge switch Q1 and the control switch Q2” refers to not only a case where the control circuit 24 switches each of the discharge switch Q1 and the control switch Q2 to be in an ON state but also a case where the control circuit 24 controls the discharge switch Q1 and the control switch Q2 to be in an OFF state.

Moreover, the control circuit 24 is configured to receive a signal from the manipulation device 4. In the present embodiment, the manipulation device 4 is configured to perform signal transmission to the control circuit 24 by wired communication or wireless communication. The wired communication is performed via a twisted pair cable, a dedicated communication line, or a local area network (LAN) cable, or the like. The wireless communication is performed by a wireless LAN, a small electric power wireless network, or infrared communication, or the like.

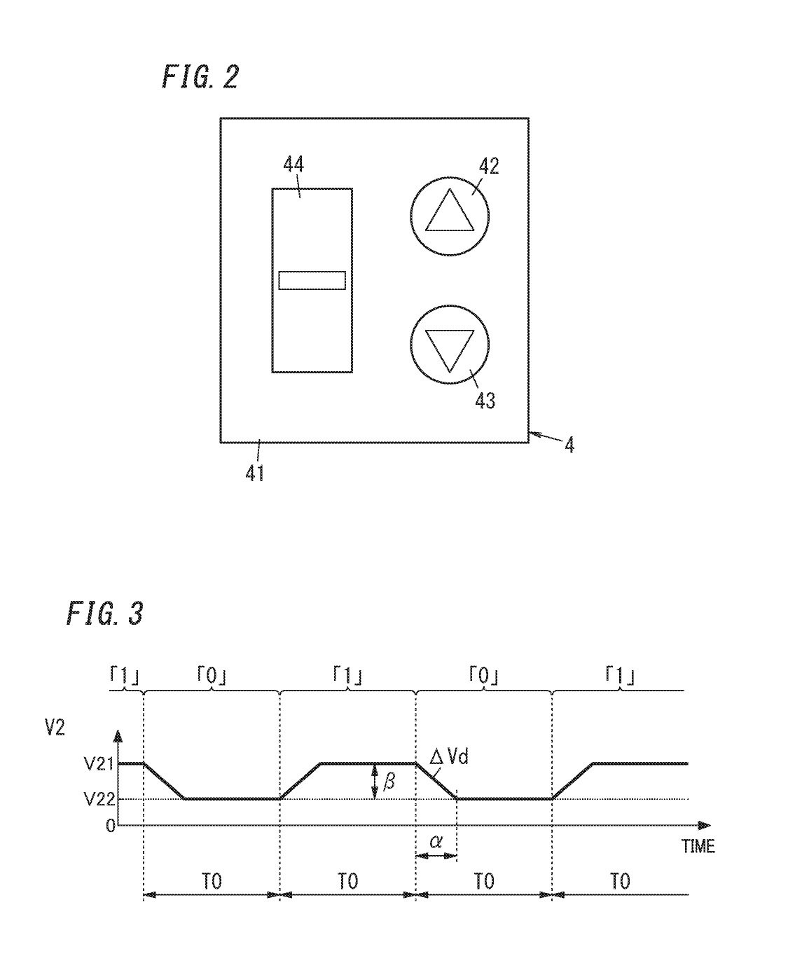

FIG. 2 shows a configuration example of the manipulation device 4. The manipulation device 4 has a housing 41 having a rectangular box shape. The housing 41 has a front surface on which buttons 42 and 43 and a display section 44 are disposed. The button 42 is pushed by a user when the dimming level of the lighting fixture 3 is increased. The button 43 is pushed by a user when the dimming level of the lighting fixture 3 is reduced. The display section 44 is configured to visually display the dimming level set by the buttons 42 and 43 and includes a level meter configured to display the dimming level by, for example, the number of bars. The manipulation device 4 may be provided to correspond to the lighting fixture 3 on a one-to-one basis or provided to correspond to a plurality of lighting fixtures 3. Moreover, the manipulation device 4 may be further provided with, for example, a button for selection of a lighting fixture 3 as a setting target of a dimming ratio from a plurality of lighting fixture 3. Note that the configuration of the manipulation device 4 is not limited to that in FIG. 2, but it is required only that the manipulation device 4 is configured to output an instruction signal.

The manipulation device 4 is configured to generate an instruction signal for an instruction of the dimming level of the lighting fixture 3 based on manipulation states of the buttons 42 and 43, and the like to output the instruction signal to the control circuit 24. The control circuit 24 is configured to receive the instruction signal from the manipulation device 4.

When receiving the instruction signal from the manipulation device 4, the control circuit 24 converts an instruction included in the instruction signal into transmission data. Then, the control circuit 24 controls the discharge switch Q1 and the control switch Q2 based on the transmission data thus converted so as to change the voltage value of the output voltage V2 to perform base band transmission of a transmission signal for controlling the lighting fixture 3 to the lighting fixture 3. The instruction included in the instruction signal of the present embodiment is an instruction for changing the dimming level of the lighting fixture 3, the output, in this embodiment, LED current, of a lighting apparatus 30 which will be described later. The instruction included in the instruction signal may be an instruction for changing the color state of the lighting fixture 3 other than the instruction for changing the dimming level.

The lighting fixture 3 includes the lighting apparatus 30 and a light source 31. The lighting apparatus 30 includes a signal receiver 301 and a constant current circuit 302. The light source 31 includes a plurality of solid-state light-emitting elements. In the present embodiment, each of the plurality of solid-state light-emitting elements is a light emitting diode (LED). The plurality of solid-state light-emitting elements are connected in series to each other. In FIG. 1, a communication system B1 includes the signal transmitter 2 and the signal receiver 301.

The signal receiver 301 monitors the output voltage V2 across the pair of feed paths E21 and E22 and compares the voltage value of the output voltage V2 with a threshold, thereby reading the transmission data from the transmission signal. That is, the signal receiver 301 is configured to detect a change of the voltage value of the output voltage V2 to acquire the transmission signal. Moreover, the signal receiver 301 is configured to output a PWM signal to the constant current circuit 302 based on the transmission signal. The signal receiver 301 is, for example, an integrated circuit (IC) for control.

For example, if the voltage value of the output voltage V2 is larger than or equal to the threshold, the signal receiver 301 determines that the transmission data is “1”, and if the voltage value of the output voltage V2 is smaller than the threshold, the signal receiver 301 determines that the transmission data is “0”. Based on the transmission data which the signal receiver 301 has read, the signal receiver 301 recognizes an instructed lighting state. The signal receiver 301 controls the constant current circuit 302 to adjust the light source 31 to be in the instructed lighting state.

In the present embodiment, as a lighting state of the light source 31, the dimming level is controlled. Based on the transmission data which the signal receiver 301 has read, the signal receiver 301 recognizes an instructed dimming level and outputs, to the constant current circuit 302, a PWM signal set to duty corresponding to the instructed dimming level. For example, the signal receiver 301 sets the duty to 100% when the dimming level is 100%, the signal receiver 301 sets the duty to 0% when the dimming level is 0%, and the signal receiver 301 sets the duty to 50% when the dimming level is 50%. That is, the signal receiver 301 is configured to control a target current value of the constant current circuit 302 so that the target current value reaches the instructed dimming level.

The constant current circuit 302 is configured to receive the output voltage V2 from the pair of feed paths E21 and E22 to supply an LED current to the light source 31 so as to light the light source 31. The constant current circuit 302 performs a constant current operation such that the value of the LED current matches with the target current value. That is, the constant current circuit 302 is configured to increase or reduce the value of the LED current in accordance with the target current value to adjust the dimming level of the light source 31. The constant current circuit 302 may be configured to perform PWM dimming of the light source 31, to perform amplitude dimming of the light source 31, or to perform the amplitude dimming and the PWM dimming in combination.

Moreover, the lighting apparatus 30 may include, for example, a step-down switching converter, a step-up switching converter, a step-up/down switching converter, or a linear regulator.

A transmission process of the transmission signal by the signal transmitter 2 will be described below in detail.

First, when the signal transmitter 2 is activated, the control circuit 24 performs a stationary operation. The control circuit 24 in the stationary operation performs control such that the discharge switch Q1 is OFF, that is, in a non-conduction state, and the control circuit 24 performs control such that the control switch Q2 is ON, that is, in a conduction state, and thereby the control circuit 24 adjusts the output voltage V2 to become equal to the input voltage V1. The control circuit 24 in the stationary operation transmits no transmission signal to the lighting fixture 3. Note that “output voltage V2 becomes equal to the input voltage V1” refers to not only a case where the difference between the input voltage V1 and the output voltage V2 becomes zero but also a case where the difference between the input voltage V1 and the output voltage V2 is a value which is small to such an extent that the difference can be regarded as substantially zero. For example, “output voltage V2 becomes equal to the input voltage V1” includes a case where the output voltage V2 becomes a smaller value than the input voltage V1 due to a voltage drop caused by an electronic component or the like included in the step-down circuit 23.

Next, when the manipulation device 4 outputs the instruction signal, and the instruction signal is input to the control circuit 24, the control circuit 24 converts the instruction included in the instruction signal into transmission data and performs a communication operation of transmitting a transmission signal corresponding to the transmission data. The control circuit 24 in the communication operation controls the discharge switch Q1 and the control switch Q2 to change the value of the output voltage V2 so as to transmit the transmission signal corresponding to the transmission data to the lighting fixture 3. Specifically, as illustrated in FIG. 3, the control circuit 24 in the communication operation controls the discharge switch Q1 and the control switch Q2 such that the value of the output voltage V2 is switched between a first voltage value V21 and a second voltage value V22. The first voltage value V21 is a value equal to the value of the input voltage V1. The second voltage value V22 is a value obtained by stepping down the input voltage V1 and is a smaller value than the first voltage value V21.

The transmission data includes a bit sequence of a plurality of bits. When the bit value of the transmission data is “1”, the control circuit 24 adjusts the value of the output voltage V2 to the first voltage value V21 so as to set the bit value of the transmission signal to “1”. Moreover, when the bit value of the transmission data is “0”, the control circuit 24 adjusts the value of the output voltage V2 to the second voltage value V22 so as to set the bit value of the transmission signal to “0”. Moreover, the control circuit 24 is configured to transmit information of each bit of the transmission signal in a period TO (see FIG. 3). That is, when the control circuit 24 transmits the transmission data, the value of the output voltage V2 for each period TO serving as a constant period is the first voltage value V21 or the second voltage value V22. Note that the period TO is set to, for example 5 ms.

The magnitude of an output current Ia supplied from the signal transmitter 2 to the pair of feed paths E21 and E22, however, varies depending on power consumption by the lighting fixture 3, in this embodiment, the sum of power consumption by the lighting apparatus 30 and power consumption by the light source 31. That is, the discharge amount of the capacitor C2 is small when the power consumption by the lighting fixture 3 is small, and the discharge amount of the capacitor C2 is large when the power consumption by the lighting fixture 3 is large. Thus, the gradient of the output voltage V2 during a reduction in the value of the output voltage V2 from the first voltage value V21 to the second voltage value V22 varies depending on the power consumption by the lighting fixture 3 in the lighting apparatus. Thus, when the value of the output voltage V2 is reduced from the first voltage value V21 to the second voltage value V22, the gradient of the output voltage V2 varies, and therefore, transmission of the transmission signal becomes instable, which may lead to communication abnormality. For example, when a reduction in the gradient of the output voltage V2 is too small, a time for which the output voltage V2 is maintained at the second voltage value V22 in the period TO becomes short, so that reading of the transmission data may fail. Note that the power consumption by the lighting fixture 3 increases as the dimming level increases, and the power consumption by the lighting fixture 3 decreases as the dimming level decreases.

In FIG. 3, a denotes a time required for the output voltage V2 to decrease from the first voltage value V21 to the second voltage value V22. In FIG. 3, β denotes the difference between the first voltage value V21 and the second voltage value V22. In this case, an absolute value ΔVd as a gradient while the output voltage V2 decreases from the first voltage value V21 to the second voltage value V22 is expressed by the following formula 1. The absolute value ΔVd of the gradient while the output voltage V2 decreases from the first voltage value V21 to the second voltage value V22 is hereinafter referred to as a voltage gradient ΔVd.

ΔVd=β/α (Formula 1)

Note that when a plurality of voltage gradients ΔVd are distinguished from each other, each of them is expressed as a voltage gradient ΔVdn (where n is a positive integer). Moreover, when a plurality of times a are distinguished from each other, each of them is expressed as a time am (where m is a positive integer).

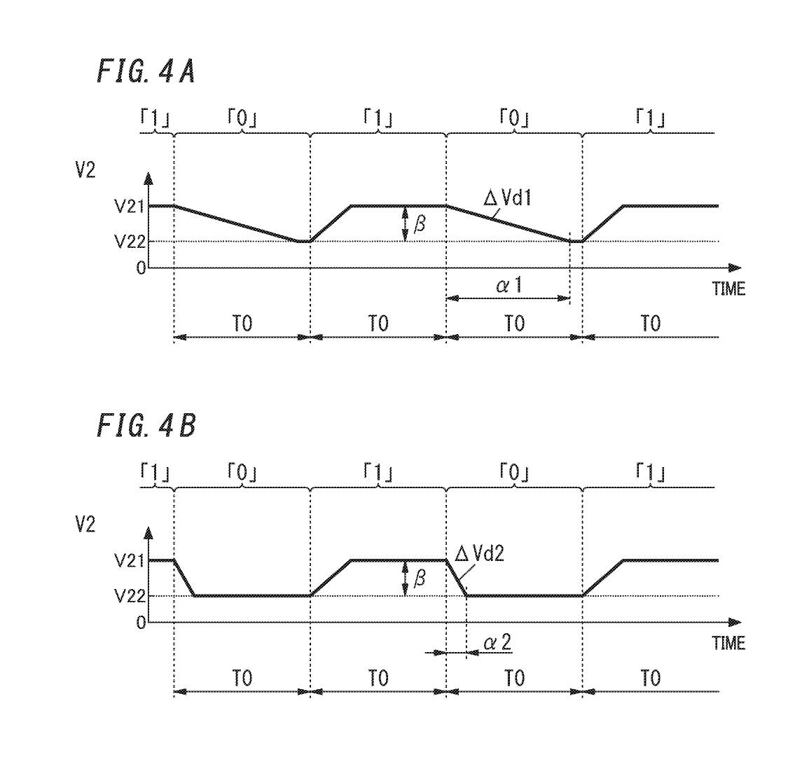

FIG. 4A shows a voltage gradient ΔVd1 in a case of a light load where the power consumption by the lighting fixture 3 is relatively small, for example, in a case where the dimming level is relatively low. The voltage gradient ΔVd1 is a voltage gradient in a case where the discharge switch Q1 and the control switch Q2 are maintained in the OFF state. In FIG. 4A, a time α1 required for the output voltage V2 to decrease from the first voltage value V21 to the second voltage value V22 is relatively long, and the voltage gradient ΔVd1 is expressed by the following formula 2.

ΔVd1=β/α1 (Formula 2)

Moreover, FIG. 4B shows a voltage gradient ΔVd2 in a case of a heavy load where the power consumption by the lighting fixture 3 is relatively large, for example, in a case where the dimming level is relatively high. The voltage gradient ΔVd2 is a voltage gradient in a case where the discharge switch Q1 and the control switch Q2 are maintained in the OFF state. In FIG. 4B, a time α2 required for the output voltage V2 to decrease from the first voltage value V21 to the second voltage value V22 is shorter than the time α1, and the voltage gradient ΔVd2 is expressed by the following formula 3.

ΔVd2=β/α2 (Formula 3)

The relationship between the voltage gradient ΔVd1 and the voltage gradient ΔVd2 is ΔVd1<ΔVd2, and the voltage gradient ΔVd1 during transmission of the transmission signal varies.

Thus, the control circuit 24 monitors the voltage gradient ΔVd of the output voltage V2 when the value of the output voltage V2 is reduced from the first voltage value V21 to the second voltage value V22, and the control circuit 24 controls the discharge switch Q1 and the control switch Q2 in accordance with the voltage gradient ΔVd. A series circuit of resistors R1 and R2 is connected between both ends of the capacitor C2. The resistor R1 is connected to a high-side end of the capacitor C2, and the resistor R2 is connected to the low-side end of the capacitor C2. The voltage across the resistor R2 is input to the control circuit 24. The control circuit 24 is configured to detect the value of the output voltage V2 based on the voltage across the resistor R2 and is also configured to obtain the voltage gradient ΔVd of the output voltage V2.

Moreover, the control circuit 24 stores data of a reference gradient range in advance. The reference gradient range represents a range of the voltage gradient ΔVd which is predetermined. The reference gradient range is set in advance to a range in which normal signal transmission by the transmission signal is possible.

Immediately after a switching process of switching the bit value of the transmission signal from “1” to “0” is started, the control circuit 24 controls the discharge switch Q1 and the control switch Q2 to be in the OFF state. The control circuit 24 controls the discharge switch Q1 and the control switch Q2 to be in the OFF state and compares a detection value of the voltage gradient ΔVd with the reference gradient range, which is prescribed. If the detection value of the voltage gradient ΔVd is within the reference gradient range, the control circuit 24 sets the operation mode of the control circuit 24 to an intermediate mode.

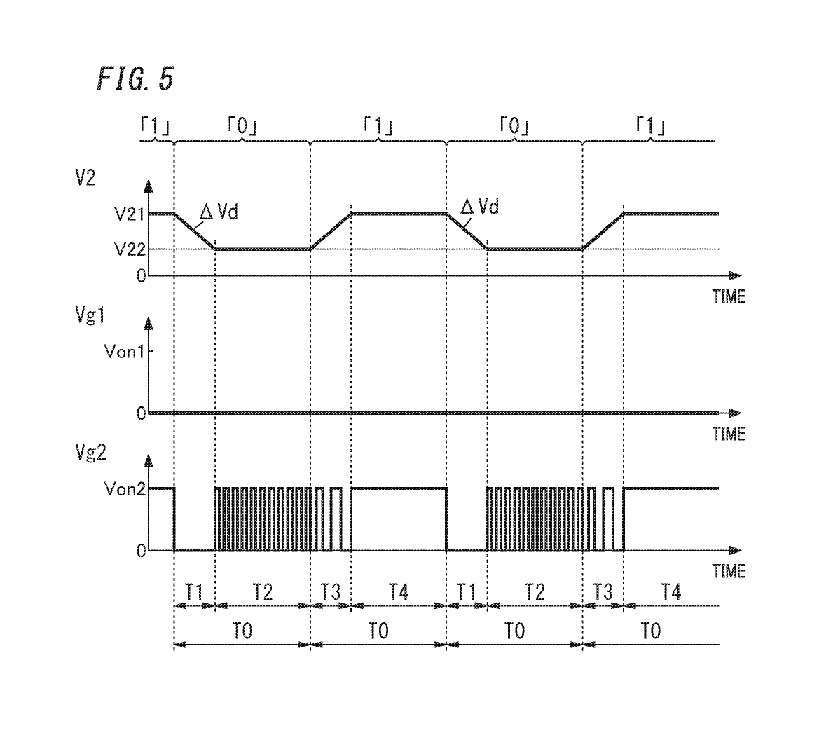

FIG. 5 shows waveforms of components when the operation mode of the control circuit 24 is set to the intermediate mode. The upper section in FIG. 5 shows the waveform of the output voltage V2, the middle section in FIG. 5 shows the waveform of the gate voltage Vg1, and the lower section in FIG. 5 shows the waveform of the gate voltage Vg2.

In FIG. 5, the bit value of the transmission signal is alternately switched between “0” and “1” for each period TO. When the control circuit 24 switches the bit value of the transmission signal from “1” to “0”, the control circuit 24 reduces the output voltage V2 from the first voltage value V21 to the second voltage value V22.

In a discharge period T1 for performing a switching process of switching the bit value of the transmission signal from “1” to “0”, the control circuit 24 in the intermediate mode adjusts the values of the gate voltages Vg1 and Vg2 to 0V and maintains the discharge switch Q1 and the control switch Q2 in the OFF state. That is, when the operation mode is in the intermediate mode, the control circuit 24 sets ON-duty of the gate voltage Vg1 and ON-duty of the gate voltage Vg2 to 0%. Thus, the capacitor C2 is discharged due to the power consumption by the lighting fixture 3, and a current flows to neither the discharge switch Q1 nor the control switch Q2.

When during a normal period T2 in FIG. 5, the output voltage V2 decreases and reaches the second voltage value V22, the control circuit 24 thereafter maintains the discharge switch Q1 in the OFF state and repeatedly turns on and off the control switch Q2 in a constant period. Thus, the control circuit 24 is configured to maintain the output voltage V2 at the second voltage value V22. The sum (T1+T2) of the discharge period T1 and the normal period T2 equals the period TO.

During a charge period T3 in FIG. 5, the next bit value of the transmission signal is “1”, and therefore, the control circuit 24 maintains the discharge switch Q1 in the OFF state and repeatedly turns on and off the control switch Q2. Thus, the control circuit 24 is configured to increase the output voltage V2 from the second voltage value V22 to the first voltage value V21.

When the output voltage V2 increases and reaches the first voltage value V21, the control circuit 24 maintains the discharge switch Q1 in the OFF state and maintains the control switch Q2 in the ON state during a normal period T4 in FIG. 5 so that output voltage V2 is maintained to be the first voltage value V21. The sum (T3+T4) of the charge period T3 and the normal period T4 equals the period TO.

The control circuit 24 thereafter repeats the operation in accordance with the bit value of the transmission signal. Note that if the bit value “1” of the transmission signal continues, the operation during the above-described normal period T4 also continues in the next period TO. Moreover, when the bit value “0” of the transmission signal continues, the operation during the above-described normal period T2 also continues in the next period TO.

The example shown in the above-described FIG. 5 corresponds to a case where the dimming level of the lighting fixture 3 is approximately intermediate and the value of the power consumption by the lighting fixture 3 is approximately medium. However, when the dimming level of the lighting fixture 3 becomes a low level, and the value of the power consumption by the lighting fixture 3 becomes relatively small, the control in the intermediate mode in FIG. 5 results in a too small voltage gradient ΔVd1.

Thus, if immediately after a switching process of switching the bit value of the transmission signal from “1” to “0” is started, the detection value of the voltage gradient ΔVd becomes smaller than the lower limit value of the reference gradient range, the control circuit 24 sets the operation mode of the control circuit 24 to the discharge mode. At this time, the discharge switch Q1 and the control switch Q2 are controlled to be in the OFF state.

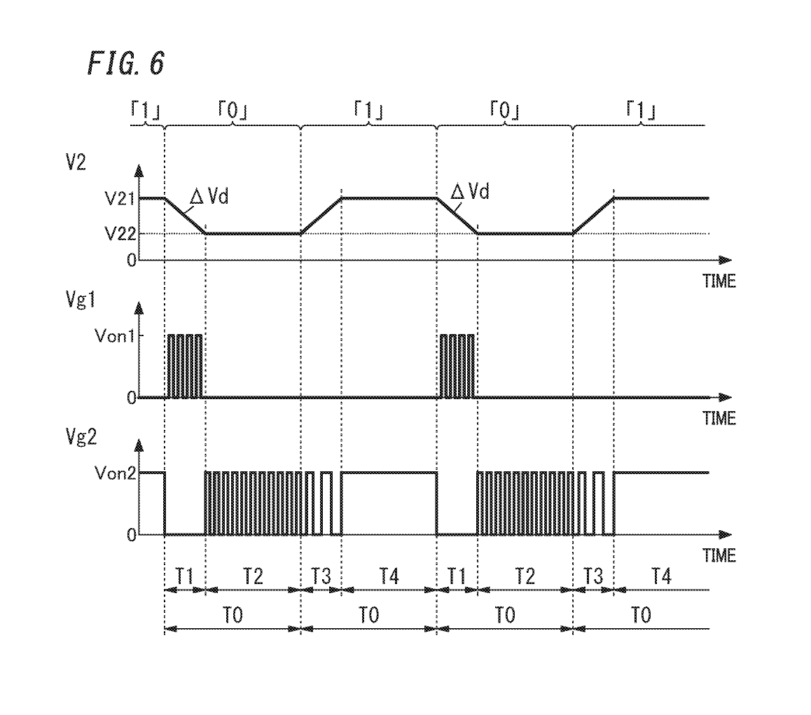

FIG. 6 shows waveforms of components when the operation mode of the control circuit 24 is set to the discharge mode. The upper section in FIG. 6 shows the waveform of the output voltage V2, the middle section in FIG. 6 shows the waveform of the gate voltage Vg1, and the lower section in FIG. 6 shows the waveform of the gate voltage Vg2.

In FIG. 6, when the control circuit 24 in the discharge mode switches the bit value of the transmission signal from “1” to “0”, the control circuit 24 in the discharge mode increases the ON-duty of the gate voltage Vg1 from 0% and repeatedly turns on and off the discharge switch Q1. Thus, electric charges accumulated in the capacitor C2 is discharged through the discharge switch Q1 when the discharge switch Q1 is ON, and therefore, the voltage gradient ΔVd increases. The control circuit 24 controls the ON-duty of the gate voltage Vg1 such that the detection value of the voltage gradient ΔVd falls within the reference gradient range.

That is, during the discharge period T1, the control circuit 24 in the discharge mode compares the detection value of the voltage gradient ΔVd with the reference gradient range and based on the comparison result, the control circuit 24 controls ON-duty of the discharge switch Q1 such that the voltage gradient ΔVd falls within the reference gradient range. Moreover, during the discharge period T1, the control circuit 24 in the discharge mode maintains the ON-duty of the gate voltage Vg2 at 0% and maintains the control switch Q2 in the OFF state. That is, the control circuit 24 in the discharge mode turns on the discharge switch Q1 and turns off the control switch Q2 to increase the voltage gradient ΔVd.

In FIG. 6, operations during the normal period T2, the charge period T3, and the normal period T4 are similar to those in FIG. 5, and thus, the description thereof is hereinafter omitted.

Moreover, when the dimming level of the lighting fixture 3 becomes a high level, and the value of the power consumption by the lighting fixture 3 becomes relatively large, the control in FIG. 5 leads to a too high voltage gradient ΔVd1.

Thus, if immediately after a switching process of switching the bit value of the transmission signal from “1” to “0” is started, the detection value of the voltage gradient ΔVd becomes larger than the upper limit value of the reference gradient range, the control circuit 24 sets the operation mode of the control circuit 24 to the switching mode. At this time, the discharge switch Q1 and the control switch Q2 are controlled to be in the OFF state.

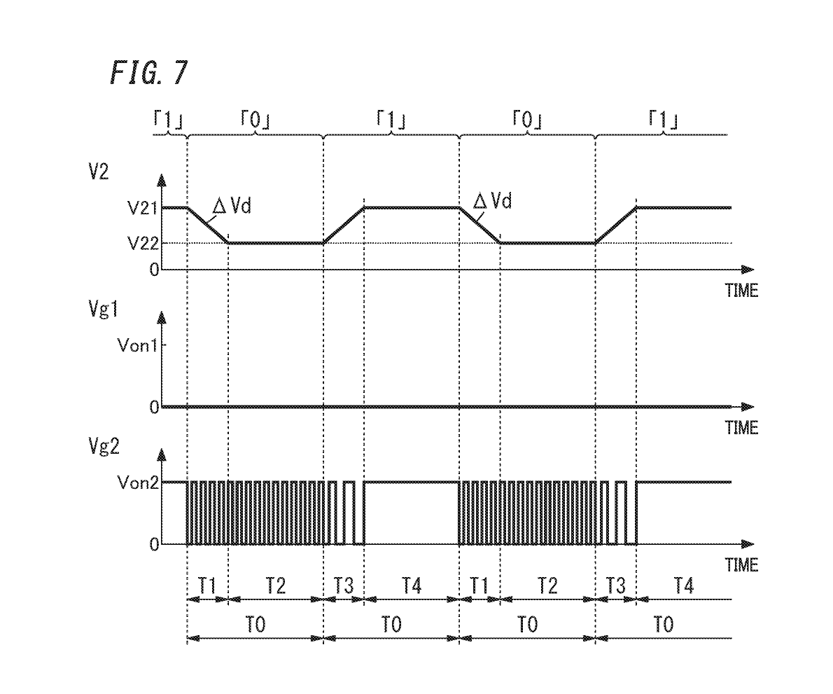

FIG. 7 shows waveforms of components when the operation mode of the control circuit 24 is set to the switching mode. The upper section in FIG. 7 shows the waveform of the output voltage V2, the middle section in FIG. 7 shows the waveform of the gate voltage Vg1, and the lower section in FIG. 7 shows the waveform of the gate voltage Vg2.

In FIG. 7, when the control circuit 24 in the switching mode switches the bit value of the transmission signal from “1” to “0”, the control circuit 24 in the switching mode increases the ON-duty of the gate voltage Vg2 from 0% and repeatedly turns on and off the control switch Q2. Thus, the capacitor C2 is charged with the direct-current voltage V1 when the control switch Q2 is ON, and therefore, the voltage gradient ΔVd decreases. The control circuit 24 controls the ON-duty of the gate voltage Vg2 such that the detection value of the voltage gradient ΔVd falls within the reference gradient range.

That is, during the discharge period T1, the control circuit 24 in the switching mode compares the detection value of the voltage gradient ΔVd with the reference gradient range, and based on a comparison result, the control circuit 24 controls ON-duty of the control switch Q2 such that the voltage gradient ΔVd falls within the reference gradient range. Moreover, in the discharge period T1, the control circuit 24 in the switching mode maintains the On-duty of the gate voltage Vg1 at 0% and maintains the discharge switch Q1 in the OFF state. That is, the control circuit 24 in the switching mode turns on the control switch Q2 and turns off the discharge switch Q1 to reduce the voltage gradient ΔVd.

In FIG. 7, operations during the normal period T2, the charge period T3, and the normal period T4 are similar to those in FIG. 5, and thus, the description thereof is hereinafter omitted.

Thus, the signal transmitter 2 is configured to cause the voltage gradient ΔVd during the discharge period T1 to be in the reference gradient range regardless of the power consumption by the lighting fixture 3. Thus, the signal transmitter 2 stabilizes signal transmission and reduces communication abnormality when a transmission signal is transmitted with a value of the output voltage V2 being changed.

Next, the transmission signal will be described. The transmission signal includes control instructions representing control contents to be given to loads such as lighting fixtures 3.

The transmission signal is a digital signal including a bit sequence including a plurality of bits as described above, and the value of the output voltage V2 corresponding to each of the plurality of bits is set to the first voltage value V21 or the second voltage value V22. In the present embodiment, if the value of the output voltage V2 is the first voltage value V21, the value of the output voltage V2 corresponds to “1”, and if the value of the output voltage V2 is the second voltage value V22, the value of the output voltage V2 corresponds to “0”. The control circuit 24 sets respective combinations of the values of the output voltage V2 to a plurality of dimming levels as instructions each to be given to the lighting fixture 3. The values of the output voltage V2 correspond to the plurality of bits. Note that the first voltage value V21 may correspond to the bit value “0”, and the second voltage value V22 may correspond to the bit value “1”.

Here, during the normal period T4 in each of FIGS. 5 to 7, the control switch Q2 is maintained in the ON state, so that the value of the output voltage V2 is maintained to be the first voltage value V21. In contrast, during the normal period T2 in each of FIGS. 5 to 7, a switching operation of repeatedly turning on and off the control switch Q2 is performed to maintain the value of the output voltage V2 to be the second voltage value V22. Thus, the switching loss, so-called electric power loss, of the control switch Q2 during the normal period T2 becomes larger than the switching loss of the control switch Q2 during the normal period T4.

Moreover, when the value of a current flowing through the control switch Q2 is larger, the switching loss of the control switch Q2 is larger, and when the value of a current flowing through the control switch Q2 is smaller, the switching loss of the control switch Q2 is smaller. That is, when the dimming level of the lighting fixture 3 (power consumption by the lighting fixture 3) is higher, the switching loss of the control switch Q2 becomes larger, and when the dimming level of the lighting fixture 3 is lower, the switching loss of the control switch Q2 is smaller.

Thus, it may be possible to reduce the switching loss of the control switch Q2 by optimizing the relationship between the dimming level and the number of bits included in the transmission signal (or the control instruction in the transmission signal) for an instruction of the dimming level and having a bit value of “0”, that is, the number of “0” bits.

For simplifying the description, a 4-bit transmission signal will be described as an example. In this case, the transmission signal is transmitted with a signal frame including a bit sequence of four bits as a communication unit.

In the 4-bit signal frame, the dimming level may be divided into 16 steps, from 0 to 15. The magnitude of the dimming level has the same meaning as the magnitude of the power consumption by the lighting fixture 3. When the number of steps of the dimming level is small, the dimming level is low, and when the number of steps is large, the dimming level is high. That is, when the dimming level is transmitted by a transmission signal adopting the 4-bit signal frame, a larger number of “0” bits leads to a longer switching time period during which the control switch Q2 performs the switching operation in the signal frame. Thus, the switching loss of the control switch Q2 increases. Moreover, since a higher dimming level leads to a larger power consumption by the lighting fixture 3, the electric power loss of the signal transmitter is larger when the number of “0” bits in the signal frame is larger and the dimming level is higher.

Table 1 shows a relationship between the dimming level and the bit configuration of a signal frame in the comparative example. In Table 1, binary numbers corresponding to the bit configuration of the signal frame are assigned to respective dimming levels corresponding to the number of steps denoted by decimal numbers 0, 1, 2 . . . 14, 15) by a common assignment method. However, in the comparative example, the relationship between the dimming level and the number of “0” bits included in the signal frame for an instruction of the dimming level is not optimized. Thus, in the signal transmitter 2 which serves both as an electric power supply and a signal transmitter as in the present embodiment, the switching loss of the control switch Q2 may become large. For example, when the dimming level [12] and the dimming level [11] are compared with each other, the power consumption by the lighting fixture 3 in the dimming level [12] is larger than that in the dimming level [11]. However, a switching time period, in this embodiment, the number of “0” bits in the signal frame during which the control switch Q2 performs the switching operation is two times that in the dimming level [11]. That is, the switching loss in a case of an instruction of the dimming level [12] is given by the transmission signal is larger than the switching loss in a case where of an instruction of the dimming level [11] is given by the transmission signal by a difference greater than or equal to the difference between dimming levels.

TABLE 1

| DIMMING LEVEL | BIT SEQUENCE | THE NUMBER OF “0” BITS |
|---|---|---|
| 15 | 1111 | 0 |
| 14 | 1110 | 1 |
| 13 | 1101 | 1 |
| 12 | 1100 | 2 |
| 11 | 1011 | 1 |
| 10 | 1010 | 2 |
| 9 | 1001 | 2 |
| 8 | 1000 | 3 |
| 7 | 0111 | 1 |
| 6 | 0110 | 2 |
| 5 | 0101 | 2 |
| 4 | 0100 | 3 |
| 3 | 0011 | 2 |
| 2 | 0010 | 3 |
| 1 | 0001 | 3 |
| 0 | 0000 | 4 |

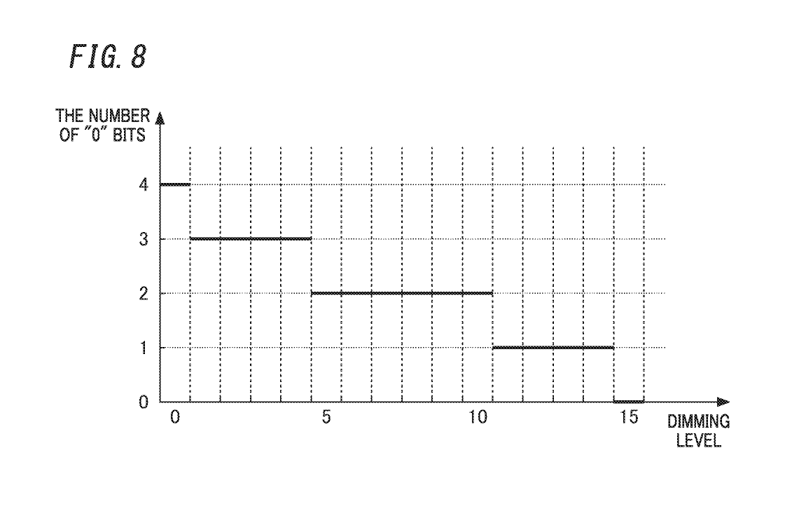

On the other hand, Table 2 shows the relationship between the dimming level and the bit configuration of the signal frame in the present embodiment. In Table 2, a bit configuration whose switching time period is longer, that is, the number of “0” bits in the signal frame is large, is assigned to a lower dimming level, and a bit configuration whose switching time period is shorter is assigned to a higher dimming level (see FIG. 8). That is, in Table 2, the relationship between the dimming level and the number of “0” bits included in the signal frame for an instruction of the dimming level is optimized. In other words, in the respective bit configurations, that is, a combination of the first voltage value V21 and the second voltage value V22, corresponding to the dimming levels 0 to 15, the proportion of bits to which the first voltage value V21 is assigned is larger in the bit configuration corresponding to a higher dimming level. When the assigning method in Table 2 is adopted, if the dimming level of the lighting fixture 3 is high, the length of the switching time period in the signal frame is reduced as compared to a case where the dimming level is low, and therefore, it is possible to reduce the switching loss over the entire dimming range.

TABLE 2

| DIMMING LEVEL | BIT SEQUENCE | THE NUMBER OF “0” BITS |
|---|---|---|
| 15 | 1111 | 0 |
| 14 | 1110 | 1 |
| 13 | 1101 | 1 |
| 12 | 1011 | 1 |
| 11 | 0111 | 1 |
| 10 | 1100 | 2 |
| 9 | 1010 | 2 |
| 8 | 1001 | 2 |
| 7 | 0110 | 2 |
| 6 | 0101 | 2 |
| 5 | 0011 | 2 |
| 4 | 1000 | 3 |
| 3 | 0100 | 3 |
| 2 | 0010 | 3 |
| 1 | 0001 | 3 |
| 0 | 0000 | 4 |

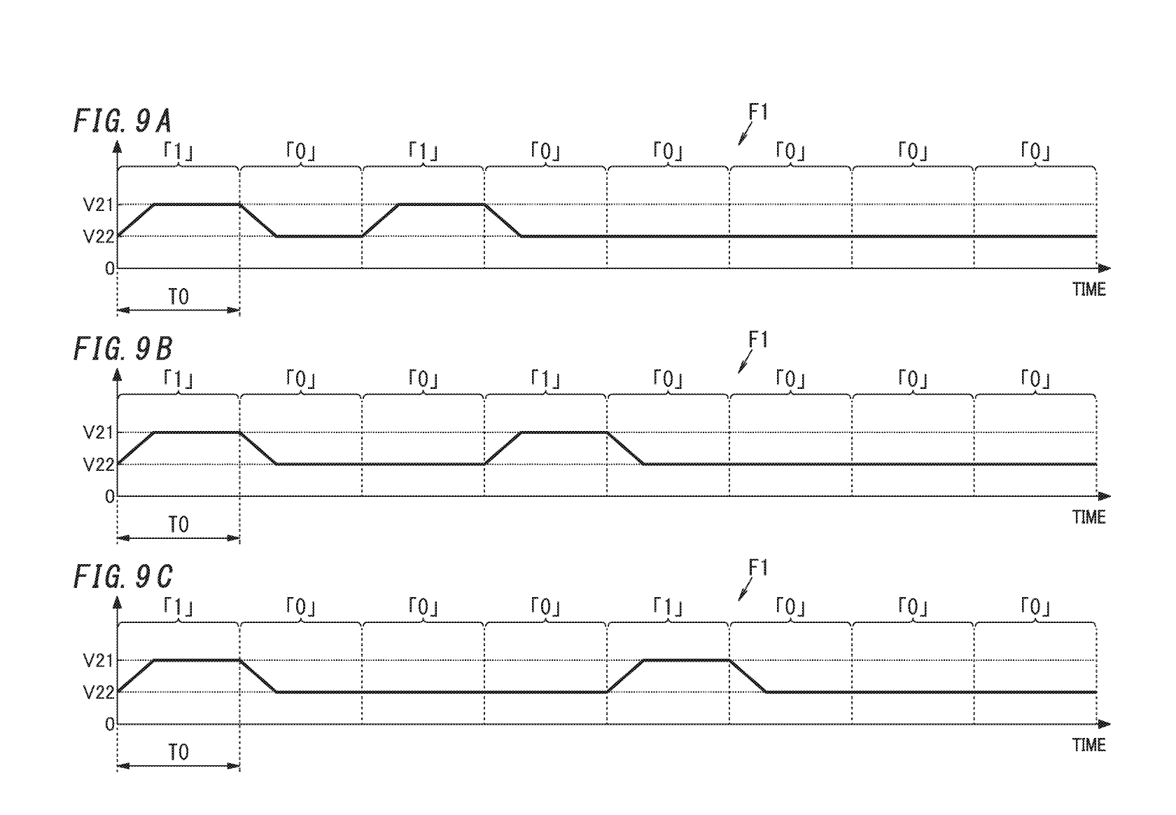

Next, an 8-bit transmission signal will be described as an example. In this case, the transmission signal is transmitted with a signal frame F1 including a bit sequence of eight bits as a communication unit as illustrated in FIGS. 9A, 9B, 9C, 10A, 10B, 10C, 11A, 11B, and 11C. In the 8-bit signal frame F1, the relationship between the dimming level and the number of “0” bits corresponding to the dimming level is optimized.

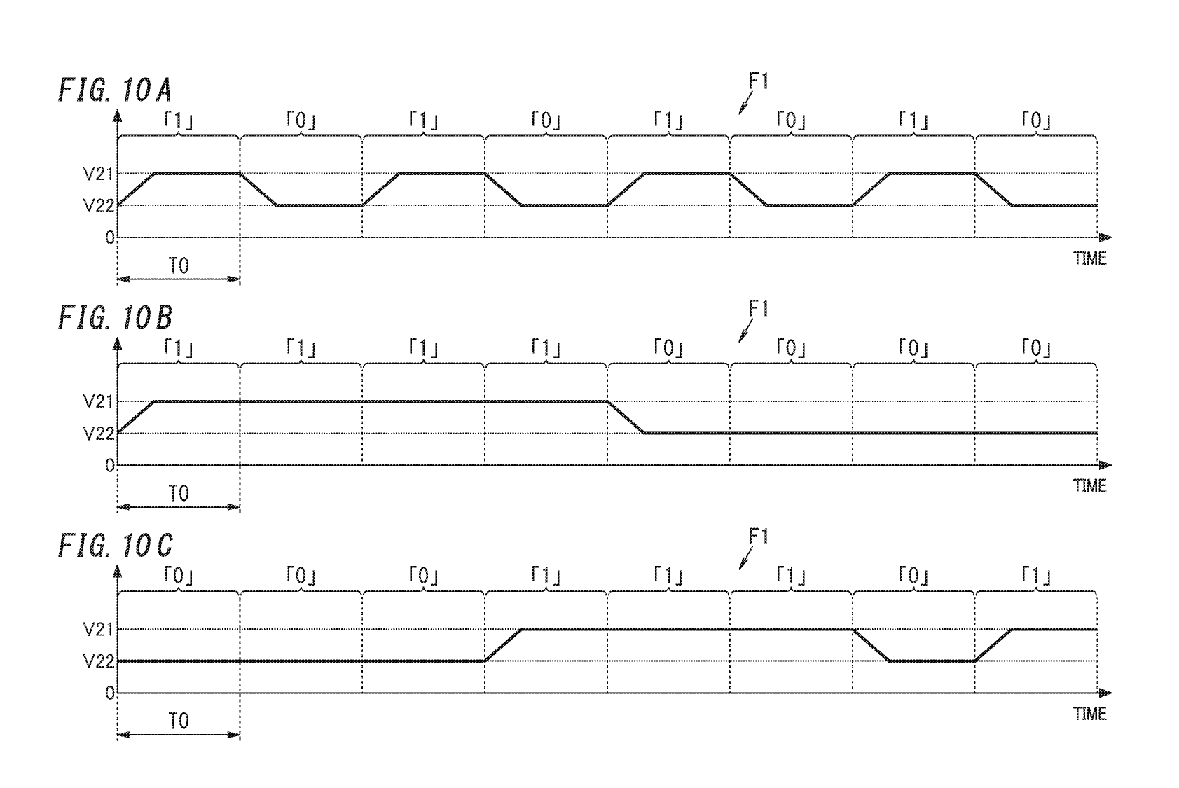

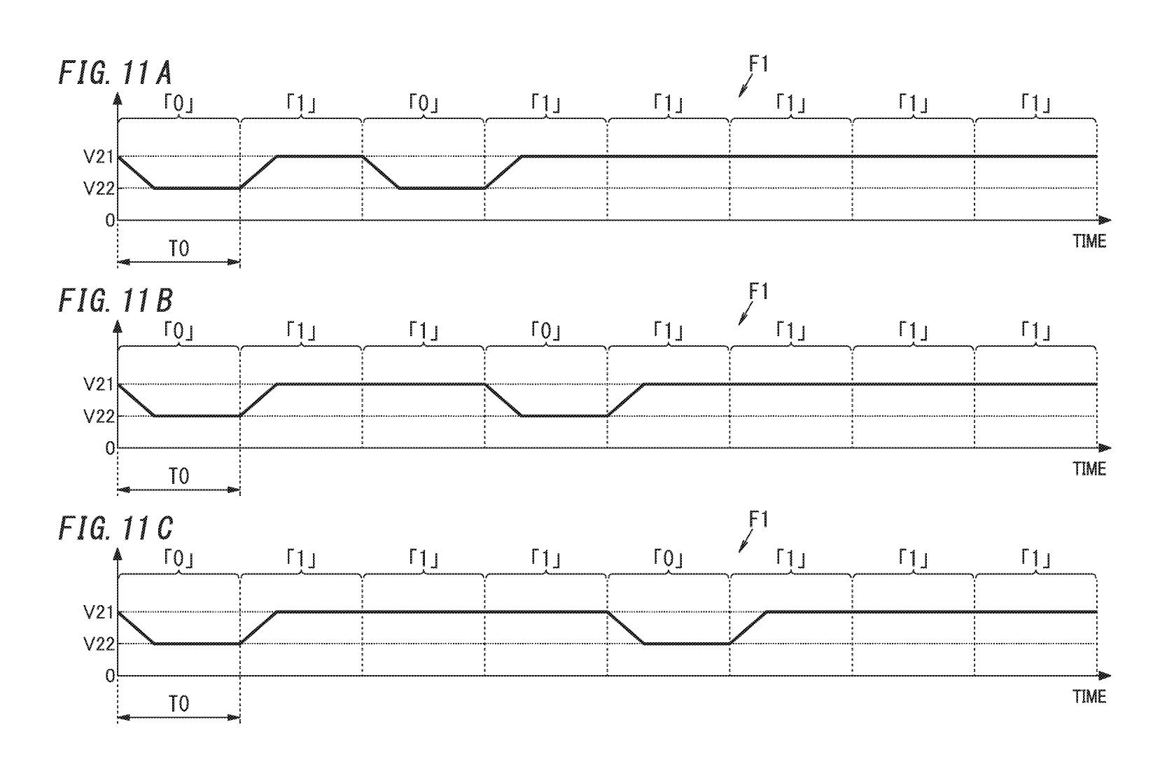

The transmission signal shown in each of FIGS. 9A, 9B, and 9C includes six “0” bits and gives an instruction of a relatively low dimming level for the entire dimming range. The transmission signal shown in each of FIGS. 10A, 10B, and 10C includes four “0” bits and gives an instruction of an approximately intermediate dimming level for the entire dimming range. The transmission signal shown in FIGS. 11A, 11B, and 11C includes two “0” bits and gives an instruction of a relatively high dimming level for the entire dimming range. Also in this case, when the dimming level of the lighting fixture 3 is high, the length of the switching time period in the signal frame decreases as compared to a case where the dimming level is low, and therefore, it is possible to reduce the switching loss over the entire dimming range.

Note that the dimming range in which the relationship between the dimming level and the number of “0” bits corresponding to the dimming level is optimized may be the entire dimming range as described above or part of the dimming range. When the dimming range in which the relationship between the dimming level and the number of “0” bits corresponding to the dimming level is optimized is part of the dimming range, the part of the dimming range is preferably a range in which the dimming level is higher than or equal to the prescribed level.

Note that the discharge switch Q1 and the control switch Q2 are not limited to an n-channel MOSFET but may be, for example, a p-channel MOSFET or the like. The signal transmitter 2 includes drive circuits for the discharge switch Q1 and the control switch Q2 in the control circuit 24 but the drive circuits may be provided outside the control circuit 24.

The control circuit 24 is not limited to a computer system but may include an application specific integrated circuit (ASIC), a field programmable gate array (FPGA), an integrated circuit (IC) for control, and the like.

The plurality of solid-state light-emitting elements included in the light source 31 are not limited to LEDs but may be other solid-state light-emitting elements such as organic electro luminescence (OEL) or a semiconductor laser diodes (LDs). Moreover, the number of solid-state light-emitting elements is not limited to more than one but may be one. The electrical connection relationship between the plurality of solid-state light-emitting elements is series connection but is not limited to this connection relationship. The electrical connection relationship between the plurality of solid-state light-emitting elements may be parallel connection or a combination of series connection and parallel connection.

The type of the lighting fixture 3 is preferably a downlight or a spotlight but may be other types.

As described above, a signal transmitter 2 of a first aspect according to the embodiment includes: a series circuit of a discharge switch Q1 and a control switch Q2; a capacitor C2; an output circuit 22; and a control circuit 24. The discharge switch Q1 and the control switch Q2 are configured to receive an input voltage V1 (a direct-current voltage). The capacitor C2 is connected in parallel to the discharge switch Q1. The output circuit 22 is configured to output the direct-current voltage of the capacitor 2C as an output voltage V2 to a load, in this embodiment, a lighting fixture 3. The control circuit 24 is configured to control the discharge switch Q1 and the control switch Q2. The capacitor C2 is charged to turn a value of the output voltage V2 into a first voltage value V21 and discharged to turn the value of the output voltage V2 into a second voltage value V22 smaller than the first voltage value V21. The control circuit 24 changes the value of the output voltage V2 into the first voltage value V21 or the second voltage value V22 by controlling the discharge switch Q1 and the control switch Q2 to generate a transmission signal. A voltage gradient ΔVd is defined as an absolute value of gradient ΔVd when the output voltage V2 is increased or decreased. The control circuit 24 controls the discharge switch Q1 and the control switch Q2 to control the voltage gradient ΔVd in accordance with a predefined criteria.

Moreover, preferably, the discharge switch Q1 and the control switch Q2 are operated to actively adjust the voltage gradient ΔVd.

Thus, the signal transmitter 2 is configured to adjust the voltage gradient ΔVd to a prescribed gradient when the value of the output voltage V2 is changed from the first voltage value V21 to the second voltage value V22 regardless of the power consumption by the lighting fixture 3 serving as an example of the load. Thus, the signal transmitter 2 stabilizes signal transmission and reduces communication abnormality when the transmission signal is transmitted with the value of the output voltage V2 being changed.

Moreover, in a signal transmitter 2 of a second aspect according to the embodiment referring to a first aspect, the control circuit 24 is configured to control the discharge switch Q1 and the control switch Q2 to reduce the voltage gradient ΔVd when the voltage gradient ΔVd becomes larger than the prescribed gradient in a case where the value of the output voltage V2 is changed from the first voltage value V21 to the second voltage value V22.

The above-described signal transmitter 2 is configured to stabilize signal transmission and reduce communication abnormality when the power consumption by the lighting fixture 3 serving as an example of the load is large.

Moreover, in a signal transmitter 2 of a third aspect according to an embodiment referring to the second aspect, the control circuit 24 is preferably configured to turn on the control switch Q2 and turn off the discharge switch Q1 to reduce the voltage gradient ΔVd.

The above-described signal transmitter 2 is configured to stabilize signal transmission and reduce communication abnormality when the power consumption by the lighting fixture 3 serving as an example of the load is large.

Moreover, in a signal transmitter 2 of a fourth aspect according to the embodiment referring to any one of the first to third aspects, the control circuit 24 is preferably configured to control the discharge switch Q1 and the control switch Q2 to increase the voltage gradient ΔVd when the voltage gradient ΔVd becomes smaller than the prescribed gradient in a case where the value of the output voltage V2 is changed from the first voltage value V21 to the second voltage value V22.

The above-described signal transmitter 2 is configured to stabilize signal transmission and reduce communication abnormality when the power consumption by the lighting fixture 3 serving as an example of the load is small.

Moreover, in a signal transmitter 2 of a fifth aspect according to the embodiment referring to the fourth aspect, the control circuit 24 is preferably configured to turn on the discharge switch Q1 and turn off the control switch Q2 to increase the voltage gradient ΔVd.

The above-described signal transmitter 2 is configured to stabilize signal transmission and reduce communication abnormality when the power consumption by the lighting fixture 3 serving as an example of the load is small.

In a signal transmitter 2 of a sixth aspect according to the embodiment referring to the fourth or fifth aspect, the control circuit 24 is configured to, when turning off the discharge switch Q1 and the control switch Q2, compare the voltage gradient ΔVd with a predetermined reference gradient range to obtain a comparison result. The control circuit 24 is preferably configured to control the discharge switch Q1 and the control switch Q2 based on the comparison result.

In a signal transmitter of a seventh aspect according to the embodiment referring to the sixth aspect, the control circuit 24 is configured to, when transitioning from the first voltage value V21 to second voltage value V22, set an operation mode of the control circuit 24 to a switching mode when the voltage gradient ΔVd is larger than an upper limit value of the reference gradient range. The control circuit 24 is preferably configured to: control the control switch Q2 to turn on and off to reduce the voltage gradient ΔVd when the operation mode is in the switching mode; and control the control switch Q2 to remain off when the operation mode is not in the switching mode.

In a signal transmitter 2 of an eighth aspect according to the embodiment referring to the seventh aspect, the control circuit is configured to, when the operation mode is in the switching mode, control ON-duty of the control switch Q2 based on the comparison result such that the voltage gradient ΔVd falls within the reference gradient range.

In a signal transmitter 2 of a ninth aspect according to the embodiment referring to any one of the sixth to eighth aspects, the control circuit 24 is configured to, when transitioning from the first voltage value V21 to second voltage value V22, set an operation mode of the control circuit 24 to a discharge mode when the voltage gradient ΔVd is smaller than a lower limit value of the reference gradient range. The control circuit 24 is configured to: control the discharge switch Q1 to turn on and off to increase the voltage gradient ΔVd when the operation mode is in the discharge mode; and control the discharge switch Q1 to remain off when the operation mode is not in the discharge mode.

In a signal transmitter 2 of a tenth aspect according to the embodiment referring to the ninth aspect, the control circuit 24 is preferably configured to control On-duty of the discharge switch Q1 based on the comparison result such that the voltage gradient ΔVd falls within the reference gradient range.

A signal transmitter 2 of an eleventh aspect according to the embodiment referring to any one of the first to tenth aspects, the transmission signal includes a bit sequence including a plurality of bits. A control instruction in the transmission signal resulting in larger power consumption by the load is predefined to include a larger proportion of bits set to the first voltage value V21 than a control instructions resulting in a lower power consumption by the load.

The signal transmitter 2 described above enables electric power loss to be reduced.

In a signal transmitter 2 of a twelfth aspect according to the embodiment referring to the eleventh aspect, the control instructions correspond to different dimming levels and are predefined such that one of the control instructions which corresponds to a higher dimming level within a prescribed range has a larger proportion of bits set to the first voltage value V21 compared to the other of the control instructions which corresponds to a lower dimming level within the prescribed range.

In the signal transmitter 2 described above, the dimming level and the combination of the value of the output voltage V2 for instruction of the dimming level can be optimized to reduce the electric power loss.

In a signal transmitter 2 of a thirteenth aspect according to the embodiment referring to the twelfth aspect, the prescribed range is preferably a range in which the dimming level is higher than or equal to a prescribed level.

The signal transmitter 2 described above enables the electric power loss to be reduced when the power consumption by the lighting fixture 3 is relatively large.

A communication system B1 of a fourteenth aspect according to the embodiment includes the signal transmitter 2 according to any one of the first to thirteenth aspects, and a signal receiver 301. The signal receiver 301 is configured to receive the transmission signal transmitted from the signal transmitter 2.

Thus, the communication system B1 is configured to stabilize signal transmission and reduce communication abnormality when the transmission signal is transmitted with the value of the output voltage V2 being changed.

A lighting system μl of a fifteenth aspect according to the embodiment includes the signal transmitter 2 according to any one of the first to thirteenth aspects, a direct-current power supply device 1, and a lighting apparatus 30. The direct-current power supply device 1 is configured to receive an alternating-current voltage and output an input voltage V1 (direct-current voltage) to the signal transmitter 2. The lighting apparatus 30 is configured to receive the output voltage V2 from the signal transmitter 2 and drive a light source 31 with the output voltage V2. The lighting apparatus 30 includes a signal receiver 301 configured to receive the transmission signal.

Thus, the lighting system μl stabilize signal transmission and reduce communication abnormality when the transmission signal is transmitted with the value of the output voltage V2 being changed.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A signal transmitter, comprising:
a series circuit of a discharge switch and a control switch, the discharge switch and the control switch being configured to receive a direct-current voltage;
a capacitor connected in parallel to the discharge switch;
an output circuit configured to output a direct-current voltage of the capacitor as an output voltage to a load; and
a control circuit configured to control the discharge switch and the control switch,
wherein:
the capacitor is charged to turn a value of the output voltage into a first voltage value and discharged to turn the value of the output voltage into a second voltage value smaller than the first voltage value;
the control circuit changes the value of the output voltage into the first voltage value or the second voltage value by controlling the discharge switch and the control switch to generate a transmission signal;
a voltage gradient is defined as an absolute value of gradient when the output voltage is increased or decreased; and
the control circuit controls the discharge switch and the control switch to control the voltage gradient in accordance with a predefined criteria.

2. The signal transmitter according to claim 1, wherein
the control circuit is configured to control the discharge switch and the control switch to reduce the voltage gradient when the voltage gradient becomes larger than the prescribed gradient in a case where the value of the output voltage is changed from the first voltage value to the second voltage value.

3. The signal transmitter according to claim 2, wherein
the control circuit is configured to turn on the control switch and turn off the discharge switch to reduce the voltage gradient.

4. The signal transmitter according to claim 1, wherein
the control circuit is configured to control the discharge switch and the control switch to increase the voltage gradient when the voltage gradient becomes smaller than the prescribed gradient in a case where the value of the output voltage is changed from the first voltage value to the second voltage value.

5. The signal transmitter according to claim 4, wherein
the control circuit is configured to turn on the discharge switch and turn off the control switch to increase the voltage gradient.

6. The signal transmitter according to claim 4, wherein
the control circuit is configured to, when turning off the discharge switch and the control switch, compare the voltage gradient with a predetermined reference gradient range to obtain a comparison result and control the discharge switch and the control switch based on the comparison result.

7. The signal transmitter according to claim 6, wherein
the control circuit is configured to, when transitioning from the first voltage value to the second voltage value,
set an operation mode of the control circuit to a switching mode when the voltage gradient is larger than an upper limit value of the reference gradient range and
controlling the control switch to turn on and off to reduce the voltage gradient when the operation mode is in the switching mode; and
controlling the control switch to remain off when the operation mode is not in the switching mode.

8. The signal transmitter according to claim 7, wherein,
the control circuit is configured to, when the operation mode is in the switching mode, control ON-duty of the control switch based on the comparison result such that the voltage gradient falls within the reference gradient range.

9. The signal transmitter according to claim 6, wherein
the control circuit is configured to, when, transitioning from the first voltage value to the second voltage value,
set an operation mode of the control circuit to a discharge mode when the voltage gradient is smaller than a lower limit value of the reference gradient range and
controlling the discharge switch to turn on and off to increase the voltage gradient when the operation mode is in the discharge mode; and
controlling the discharge switch to remain off when the operation mode is not in the discharge mode.

10. The signal transmitter according to claim 9, wherein
the control circuit is configured to control ON-duty of the discharge switch based on the comparison result such that the voltage gradient falls within the reference gradient range.

11. The signal transmitter according to claim 1,
wherein the transmission signal includes a bit sequence including a plurality of bits, and
a control instruction in the transmission signal resulting in larger power consumption by the load is predefined to include a larger proportion of bits set to the first voltage value than a control instruction resulting in lower power consumption by the load.

12. The signal transmitter according to claim 11,
wherein the control instructions correspond to different dimming levels and are predefined such that one of the control instructions which corresponds to a higher dimming level within a prescribed range has a larger proportion of bits set to the first voltage value compared to the other of the control instructions which corresponds to a lower dimming level within the prescribed range.

13. The signal transmitter according to claim 12, wherein
the prescribed range is a range in which the dimming level is higher than or equal to a prescribed level.

14. A communication system, comprising:
the signal transmitter according to claim 1; and
a signal receiver configured to receive the transmission signal transmitted from the signal transmitter.

15. A lighting system, comprising:
the signal transmitter according to claim 1;
a direct-current power supply device configured to receive an alternating-current voltage and output a direct-current voltage to the signal transmitter; and
a lighting apparatus configured to receive the output voltage from the signal transmitter and drive a light source with the output voltage, wherein
the lighting apparatus includes a signal receiver configured to receive the transmission signal.
